(19) United States
(12) Patent Application Publication
(10) Pub. No.: US 2006/0202786 A1
(43) Pub. Date: Sep. 14, 2006

(54) Voltmeter relay with rigid connectors designed to connect the coil wire to faston terminals

(75) Inventor: Pietro Cecconi, Monza (IT)

Correspondence Address: YOUNG & THOMPSON, 745 SOUTH 23RD STREET, 2ND FLOOR, ARLINGTON, VA, 22202, US

(73) Assignee: ELECTRICA S.R.L., MILANO (IT)

(21) Appl. No.: 11/362,113

(22) Filed: Feb. 27, 2006

(30) Foreign Application Priority Data
Mar. 10, 2005 (IT) PC 2005 U 000005

(51) Int. Cl. H01H 67/02

(52) U.S. Cl. 335/128

(57) ABSTRACT

A voltage sensitive relay, in particular of the type designed to provide the starting current of refrigerator compressor motors, wherein the excitation coil (2) of the relay is connected to faston terminals (8, 9), fitted at the base (1), via rigid connectors (15, 16) which are press-fitted, simply by insertion onto the faston terminals, with an end tab (22, 27) which is simultaneously inserted into a seating (12, 13) that contains the metal contacts to which the ends of the coil wire are soldered. In view of the particular configuration of the parts, a voltage sensitive relay of considerable practicality and convenience is obtained, which eliminates numerous soldering operations, and can therefore be assembled more quickly and easily than known voltage sensitive relays.

The present invention relates to a voltage sensitive relay, or voltmeter relay, in particular of the type designed to provide the starting current of refrigerator compressor motors, wherein the excitation coil of the relay is connected to faston terminals, fitted at the base, via rigid connectors which are press-fitted, simply by insertion onto the faston terminals, with an end tab which is simultaneously inserted into a seating that contains the metal contacts to which the ends of the coil wire are soldered.

In view of the particular configuration of the parts, a voltage sensitive relay of considerable practicality and convenience is obtained, which eliminates numerous soldering operations, and can therefore be assembled more quickly and easily than known voltage sensitive relays.

In refrigerators, the motor/compressor assembly is generally made in a single hermetically sealed block, contained in a metal casing fitted with suitable connectors for connection to the power cables and the motor starting and protection devices.

Said connectors are of a standardised type and generally comprise three male contacts, to which a starting or starting and protection device is fitted, which said device comprises means able to provide for a short time the pick-up current required to start the motor, and heat-activated protection devices.

Many starter devices are constituted by a relay, the contacts of which are closed for as long as necessary to supply the pick-up current to the motor windings; said relay opens when the motor reaches the required number of revolutions, thus cutting off said pick-up current, so that the motor only receives the current required to power it.

In the relays currently available, the ends of the coil wire are soldered to electrical contacts or plugs fixed to one of the coil supports, which in turn are connected to faston terminals mounted on the relay base via an insulated wire: the ends of said wire are soldered to the coil contact and faston respectively, and are then bent and passed manually along the perimeter of the base, so that they do not interfere with moving parts.

This system is rather onerous, because it requires soldering operations which could otherwise be avoided (the coils are usually made separately, with the ends of the wire already soldered to the contacts present on the support) and because it requires a manual wire-positioning operation.

As these are low-cost devices, each operation, such as soldering, and each manual action, such as wire positioning, is rather onerous; eliminating these operations and fully automating the assembly of the relay would therefore be highly advantageous and bring considerable benefits, namely savings of time and costs.

This problem is now solved by the present invention, which relates to a voltage sensitive relay wherein the coil wire is connected to the faston terminals by means of rigid connectors, designed so that they can be fitted simply by pressing them into place, with no need for soldering and the like. As these connectors are made of sheet metal, they can be rapidly made by blanking and forming, so that the voltage sensitive relay manufacturing and assembly cycle can be fully automated.

This invention will be better understood from the following detailed description, provided by way of example but not of limitation, with reference to the enclosed drawings, wherein:

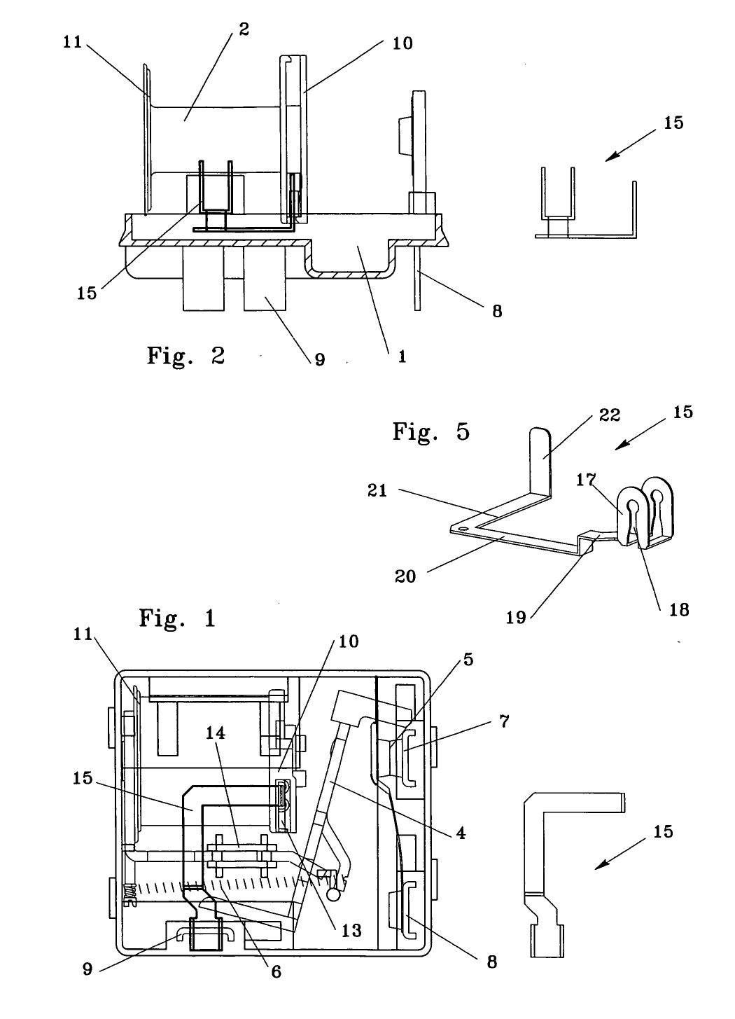

FIG. 1 is a plan view of a relay according to the invention, open, showing the first of the conductors that connect the coil to the faston terminals;

FIG. 2 is a vertical cross-section of the device shown in FIG. 1;

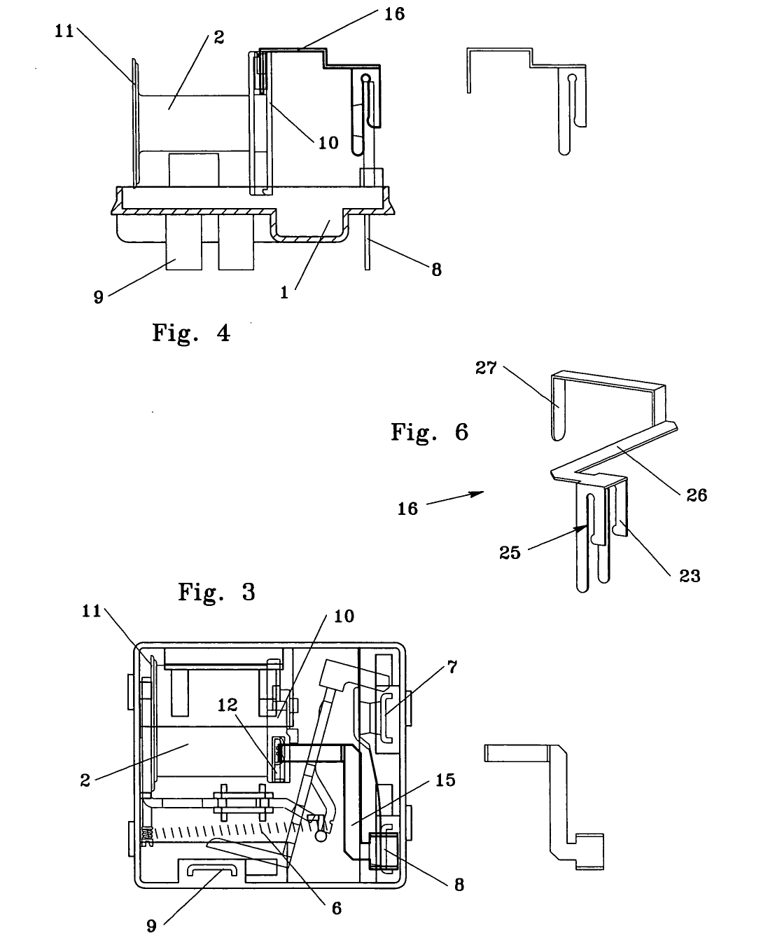

FIG. 3 is a plan view of the same device, showing the second connector;

FIG. 4 is a vertical cross-section of the device shown in FIG. 3;

FIGS. 5 and 6 are perspective views of the connectors;

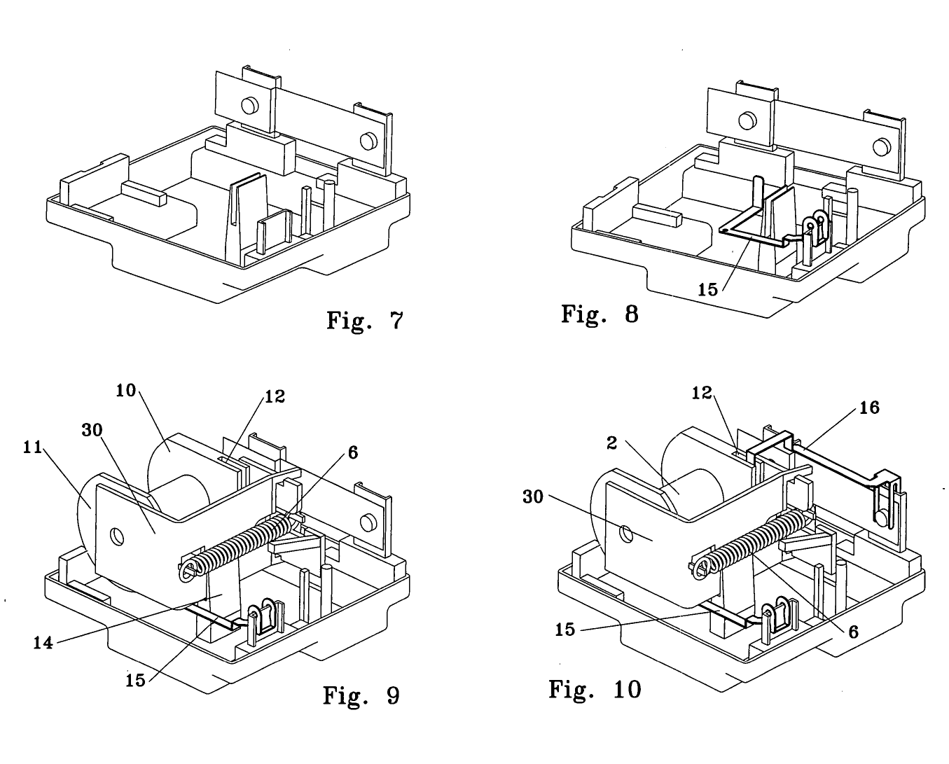

FIGS. 7 to 10 are perspective views of the relay according to the invention, open, during the various stages of assembly.

As shown in the annexed figures, the voltage sensitive relay according to the invention comprises a base 1, for example made of moulded plastic, closed by a lid not shown, on which are mounted the various components of a relay, including a coil 2 and a support of a movable arm 4 which engages a movable contact 5 and is subject to the action of a spring 6.

A set of faston terminals shown as 7, 8 and 9 are attached to base 1, and project from the bottom of it.

Two of said terminals, namely terminals 8 and 9, are connected to the ends of the coil winding.

The latter is fitted on supports 10 and 11 made of plastic or other suitable material.

The upper and lower parts of support 10 contain a pair of seatings 12 and 13 respectively, in which are inserted metal plugs or contacts to which the coil wire is soldered.

The coil is manufactured separately, ready assembled, with the contacts fitted and the wire soldered.

The base is also integral with a support 14 into which is inserted a metal part 30, to which the coil is fixed and on which movable arm 4 is also mounted.

To connect the contacts in the coil support to terminals 8 and 9, the invention provides a pair of lower and upper movable connectors 15 and 16, shown in FIGS. 5 and 6 respectively.

The first of said connectors comprises a pair of wings 17 with slots 18 which enable them to be inserted on terminal 9. From wings 17 leads a strip that presents a first section 19 which is inclined downwards until it is close to base 1, and continues with a pair of arms 20 and 21 at a 90° angle, arm 21 terminating with a wing 22 bent upwards.

The dimensions of the connector are such that when wings 17 are inserted onto terminal 9, wing 22 is under coil support 10, in correspondence with slot 12, which gives access to seating 13 containing the first of the contacts to which the coil wire is soldered.

The second connector 16, shown in FIG. 6, also comprises a pair of wings 23 with slots 25 that allow it to be inserted onto terminal 8.

The base of the wings continues with an arm 26 constituted by a strip comprising various sections at 90° angles to one another, wherein the last section, shown as 27, faces downwards and forms a wing designed to be inserted, when the connector is mounted on terminal 8, into seating 12 of the coil support, which contains the second contact to which the wire is soldered.

The assembly of the relay thus designed is extremely simple.

Connector 15 is first mounted on the base, already fitted with terminals (FIG. 7), by inserting wings 17 onto terminal 9 (FIG. 8).

The assembly constituted by L-shaped support 30 and the coil integral with it is then mounted by inserting the L-shaped arm into support 14 fitted on the base (FIG. 9).

When the coil is correctly positioned, the slot that gives access to seating 13 is positioned exactly above wing 22 of connector 15.

When the L-shaped support 30 with the coil is pushed downwards to insert it onto support 14, wing 22 penetrates into seating 13 and engages the first contact to which the coil wire is soldered (FIG. 10).

Connector 16 is then mounted by inserting wings 23 onto terminal 8; wing 27 is inserted into seating 12 of coil support 10, and engages the second contact to which the coil wire is soldered.

When the other components, such as the return spring of movable arm 4, have been fitted, the assembly is complete, and the device can be closed by snap-fitting the lid onto base 1.

As will be clear from the description supplied, due to the particular configuration of the parts of the voltage sensitive relay according to the invention, and especially of connectors 15 and 16, assembly of the device can be fully automated because the various components can be fitted simply by inserting them onto the corresponding supports after positioning them correctly in relation to the base.

They also offer considerable environmental advantages, because there is no need for soldering and the consequent development of fumes and the use of soldering pastes.

The dimensions and the materials employed can obviously vary, depending on use.

1) Voltage sensitive relay of the type comprising a base fitted with a set of faston terminals and closed by a lid, on which are mounted a coil, a support for a movable contact, and elastic return means for said movable contact, characterised in that said relay includes rigid connectors to connect the ends of the coil wire to the corresponding faston terminals.

2) Voltage sensitive relay as claimed in claim 1, characterised in that said connectors comprise on one side one or more wings with a slot that enables them to be inserted onto the corresponding faston terminal, and on the other side, a wing designed to be inserted into a corresponding seating in the coil support, electrical contacts connected to the coil wire being present in said seatings.

3) Voltage sensitive relay as claimed in claim 2, characterised in that one of said connectors comprises a pair of wings designed to be inserted onto the corresponding faston, and an arm constituted by a strip, the end of which is bent upwards to form a wing designed to be inserted into a seating in the coil support, wherein is housed an electrical contact to which one end of the coil wire is soldered, the second of said connectors being constituted by an arm fitted on one side with a pair of wings with a slot allowing insertion onto the corresponding faston terminal, and on the other side, a section bent downwards to form a wing designed to be inserted into seating 12 in the coil support, which also contains one of the terminals to which said wire is soldered.
